(19) United States
(12) Patent Application Publication
(10) Pub. No.: US 2007/0041047 A1
(43) Pub. Date: Feb. 22, 2007

(54) Image forming device and authentication charging method

(76) Inventor: Satoru Sugishita, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/500,955

(22) Filed: Aug. 9, 2006

(30) Foreign Application Priority Data
Aug. 19, 2005 (JP) 2005-238753
Jun. 9, 2006 (JP) 2006-161402

(51) Int. Cl. G06F 3/12

(52) U.S. Cl. 358/1.15; 358/1.14

(57) ABSTRACT

In an image forming device including a hardware resource used in image formation processing and an application program performing the image formation processing, an application-specific authentication unit is specifically adapted for control of one of a plurality of authentication/changing methods. A common authentication unit provides the application program with a common interface irrespective of a kind of the application-specific authentication unit.

### BACKGROUND OF THE INVENTION

1. Field of the Invention

The present invention relates to an image forming device which performs authentication and charging processing, and an authentication charging method for use in the image forming device.

2. Description of the Related Art

In recent years, an image forming device, such as a multi-function peripheral (MFP), in which a plurality of image formation processing functions, including a fax function, a printer function, a copy function and a scanner function, are incorporated in a single housing of the device is known.

This image forming device is provided with a display unit, a printing unit and an image capturing unit, which are common hardware resources included in the housing, and it includes the four kinds of application programs respectively corresponding to the fax, the printer, the copy and the scanner functions as the internal software. One of such application programs is switched between them and the common hardware resources are used, so that any of the fax function, the printer function, the copy function and the scanner function can be realized.

It is known that authenticating and charging processing is performed in the above-mentioned image forming device. In a conventional image forming device, it is required that the application program operates while it directly recognizes the kind of the authentication/charging method, such as a user code, a key counter or a keycard, in order to perform the authentication and charging processing.

In the case of the conventional image forming device, each time a new authentication method or a new charging method is additionally installed, correction of the authentication module and the application program in combination to the software composition of the conventional image forming device must be performed.

For this reason, in order to make the software composition extend to install the new authentication method, such as access roll (personal authentication by a user login), which is not included in the conventional image forming device, correction measures for all the application programs must be taken. Thus, it is difficult to make the software composition of the conventional image forming device extend to install the new authentication method.

### SUMMARY OF THE INVENTION

According to one aspect of the invention, there is provided an improved image forming device and certification and charging method in which the above-described problems are eliminated.

According to one aspect of the invention there is provided an image forming device which can be easily extended to install a new authentication method or a new charging method.

According to one aspect of the invention there is provided an authentication charging method for use in an image forming device which can be easily extended to install a new authentication method or a new charging method.

In an embodiment of the invention which solves or reduces one or more of the above-mentioned problems, there is provided an image forming device including a hardware resource used in image formation processing, and an application program performing the image formation processing, the image forming device comprising: at least one application-specific authentication unit specifically adapted for control of one or more of a plurality of authentication/charging methods; and a common authentication unit providing the application program with a common interface irrespective of a kind of the at least one application-specific authentication unit.

The above-mentioned image forming device may be configured so that the application-specific authentication unit comprises: a communication unit which communicates with a device used in the one or more of the plurality of authentication/charging methods; and an authentication control unit which communicates with the device using the communication unit and controls the one or more of the plurality of authentication/charging methods.

The above-mentioned image forming device may be configured so that the communication unit is provided to perform a registration to the application-specific authentication unit to notify existence of the communication unit to the application-specific authentication unit, and the authentication control unit is provided to perform a registration to the common authentication unit to notify existence of the authentication control unit to the common authentication unit.

The above-mentioned image forming device may be configured so that the common authentication unit is provided to send charging setting information to the authentication control unit if needed.

The above-mentioned image forming device may be configured so that the image forming device further comprises a device management setting menu unit controlling displaying of an authentication-related operation setting menu to a user, and the common authentication unit determining contents of the operation setting menu in accordance with operation setting information registered by the authentication control unit.

The above-mentioned image forming device may be configured so that the displayed operation setting menu includes a character string.

The above-mentioned image forming device may be configured so that the common authentication unit is provided to start the authentication control unit only when the authentication control unit is predetermined as being started.

The above-mentioned image forming device may be configured so that the image forming device further comprises: an extended communication unit adapted for an extended authentication method; and an extended authentication control unit adapted for control of the extended authentication method.

The above-mentioned image forming device may be configured so that the extended communication unit and the extended authentication control unit are recorded on another storage medium separated from the image forming device, and the image forming device is provided to start the extended communication unit and the extended authentication control unit from the storage medium.

The above-mentioned image forming device may be configured so that the image forming device further comprising an existence checking unit checking whether the extended authentication control unit exists.

The above-mentioned image forming device may be configured so that, when it is checked by the existence checking unit that the extended authentication control unit does not exist, an error message, including a cause of an error and a restoration method of the error, is displayed.

Furthermore, in an embodiment of the invention which solves or reduces one or more of the above-mentioned problems, there is provided an authentication charging method for use in an image forming device including a hardware resource used in image formation processing and an application program performing the image formation processing, the method comprising: acquiring, from a device management setting menu unit, operation setting information which indicates a kind of authentication method or charging method specified by a user; starting an application-specific authentication unit corresponding to the acquired operation setting information, the application-specific authentication unit being specifically adapted for control of one or more of a plurality of authentication/charging methods and including a communication unit and an authentication control unit; determining contents of operation setting of the authentication control unit in accordance with the operation setting information and notifying the contents of the operation setting to the started application-specific authentication unit; and notifying the contents of the operation setting and a current authentication state to the application program.

The above-mentioned authentication charging method may be configured so that the method further comprises the step of outputting an error message request when an error occurs in the application-specific authentication unit, in order to display the occurrence of the error to the user.

The above-mentioned authentication charging method may be configured so that the image forming device further comprises an extended authentication unit adapted for an extended authentication method, and an existence checking unit checking existence of the extended authentication unit, and that, when the extended authentication unit is started, the existence checking unit is used to check existence of the extended authentication unit.

The above-mentioned authentication charging method may be configured so that, when the extended authentication unit is used, the device management setting menu unit is requested to display an operation setting menu corresponding to the extended authentication unit.

According to embodiments of the image forming device and authentication charging method of the invention, extension of the software composition to install a new authentication method or a new charging method can be attained easily.

### BRIEF DESCRIPTION OF THE DRAWINGS

Other objects, features and advantages of the present invention will be apparent from the following detailed description when reading in conjunction with the accompanying drawings.

FIG. 1 is a diagram showing the software composition of the MFP (multi-function peripheral) in an embodiment of the invention.

FIG. 2 is a diagram showing the hardware configuration of the MFP in an embodiment of the invention.

FIG. 3 is a diagram showing the thread composition of the CCS in the programs shown in FIG. 1.

FIG. 4 is a diagram showing the arrangement of programs in the ROM.

FIG. 5 is a diagram showing the arrangement of programs in the ROM.

FIG. 6 is a sequence diagram for explaining the starting procedure of the CCS and the CCM.

FIG. 7 is a sequence diagram for explaining the starting procedure of the extended CCM and the extended IO.

FIG. 8 is a sequence diagram for explaining an error judgment at the time of starting of the CCS and the CCM.

FIG. 9 is a diagram showing an error screen.

FIG. 10 is a sequence diagram for explaining the operation setting screen creation procedure of the extended CCM.

FIG. 11A and FIG. 11B are diagrams showing examples of the operation setting screen of the extended CCM.

### DETAILED DESCRIPTION OF PREFERRED EMBODIMENTS

A description will be given of embodiments of the invention with reference to the accompanying drawings.

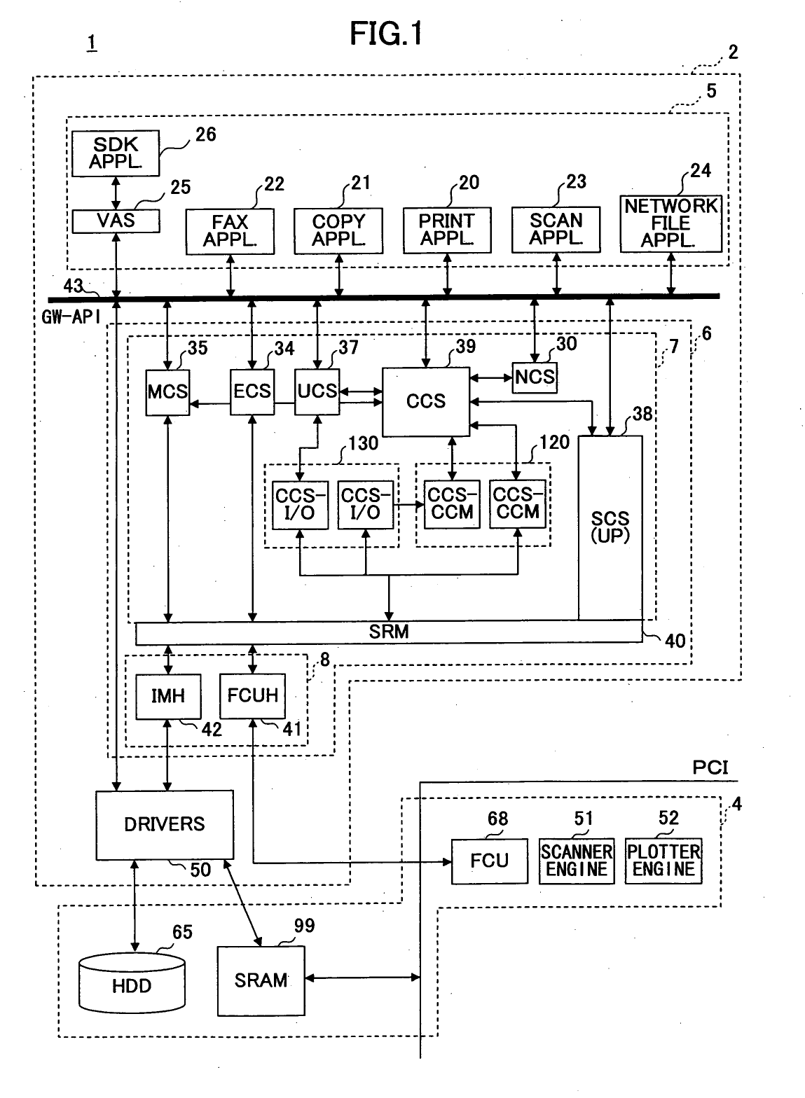

FIG. 1 shows the software composition of the MFP (multi-function peripheral) in an embodiment of the invention.

In the following explanation, the MFP1 is mentioned as an example of the image forming device of the invention, and the software composition of the MFP1 will be explained.

As shown in FIG. 1, the MFP1 is provided with the programs 2 as the mounted software, and the hardware resources 4 used in image formation processing. Upon powering on, the MFP1 starts the application layer 5 and the controller layer 6. For example, the MFP1 reads the programs of the application layer 5 and the controller layer 6 from the hard disk drive (HDD) 65, transfers the read programs to the memory area, and starts them.

The hardware resources 4 include the scanner engine 51, the plotter engine 52, the FCU 68 that will be described later, the SRAM 99 and the HDD 65.

The programs 2 include the application layer 5 and the controller layer 6 which are started on the operating system (OS), such as UNIX (registered trademark). The application layer 5 contains the drivers 50 and the programs which respectively perform image-formation processing functions, specific to user service, including the printer function, the copy function, the fax function and the scanner function.

The application layer 5 is provided with the following application programs: the printer application 20 which is the application program for a printer; the copy application 21 which is the application program for a copier; the fax application 22 which is the application program for a fax; the scanner application 23 which is the application program for a scanner, and the network file application 24.

Moreover, the application layer 5 is provided with the SDK (software development kit) 26 and the VAS (virtual application service) 25.

The controller layer 6 is provided with the following layers: the control service layer 7 which interprets the processing request from the application layer 5 and generates the acquisition request of the hardware resources; the system resource manager (SRM) 40 which manages one or more hardware resources and arbitrates the acquisition request from the control service layer 7; and the handler layer 8 which manages the hardware resources in accordance with the acquisition request from the SRM 40.

The control service layer 7 is provided to include one or more services modules which include the network control service (NCS) 30, the engine control service (ECS) 34, the memory control service (MCS) 35, the user information control service (UCS) 37, the system control service (SCS) 38, the certification and charge control service (CCS) 39, the CCS-I/O (IO) 130, and the CCS-CCM (CCM) 120.

The controller layer 6 is provided with the predetermined functions so that it includes the GW-API43 which enables receiving of the processing request from the application layer 5. The OS (operating system) carries out parallel execution of the respective programs of the application layer 5 and the controller layer 6 as the processes.

The process of NCS 30 offers the service which can be used in common to the application program which needs the network I/O, performs the intermediary process at the time of distributing the data received by each protocol from the network side to each application program, and performs the intermediary process at the time of transmitting the data from each application program to the network side.

For example, the NCS 30 controls the data communication with a network device connected through the network, by using the HTTP (hypertext transfer protocol) according to the HTTPD (hypertext transfer protocol daemon).

The process of ECS 34 controls the engine units, such as the scanner engine 51, the plotter engine 52, and the other hardware resources. The process of MCS 35 performs the memory control of the acquisition and releasing of the memory, the use of HDD, etc. The process of UCS 37 manages the user information. The CCS 39, the IO 130 and the CCM 120 will be explained later.

The process of SCS 38 processes the application management, the operation panel control, the system screen display, the LED display, the hardware-resources management, the interruption application control, etc. In the present embodiment, the UP (user program management module) included in the SCS 38 will be mentioned later as an example of the module of the SCS 38 that manages the user setting information for use in the certification and charge processing according to the invention.

The process of SRM 40 performs control of the system and management of the hardware resources in association with SCS 38. For example, according to the acquisition request from the high order layer using the hardware resources, the process of SRM 40 arbitrates the request and carries out the execution control.

Specifically, the process of SRM 40 determines whether the hardware resources to which the acquisition request is sent can be used (or whether the hardware resources are already used by another acquisition request). If the use of the hardware resources is possible, the process of SRM 40 will notify to the high order layer that the hardware resources to which the acquisition request is sent can be used.

Moreover, the process of SRM 40 performs the scheduling of the acquisition request from the high order layer for using the hardware resources, and directly deals with the contents of the request (for example, paper conveyance and imaging operation by the printer engine, memory reservation, file creation, etc.).

Moreover, the handler layer 8 includes the facsimile control-unit handler (FCUH) 41 which manages the facsimile control unit (FCU), and the image memory handler (IMH) 41 which manages the assignment of the memory to the process and manages the memory assigned to the process.

The SRM 40 and the FCUH 41 make it possible to send the processing request to the hardware resources according to the pre-defined function, and they send the processing request to the hardware resources using the engine I/F 44.

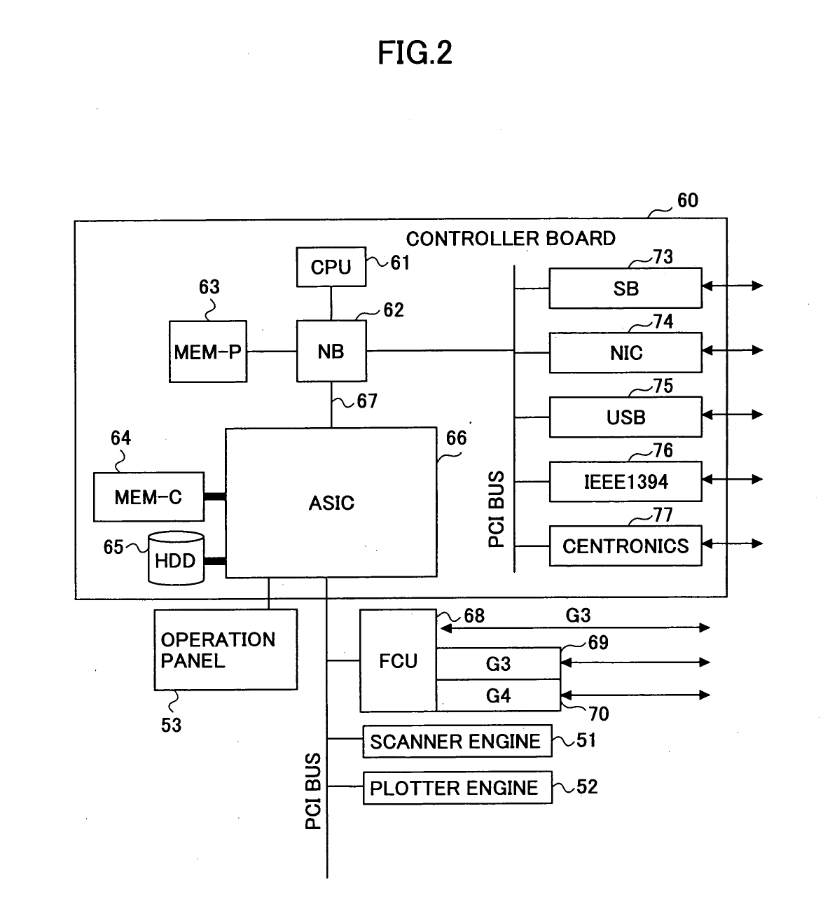

FIG. 2 shows the hardware configuration of the MFP1 in an embodiment of the invention.

As shown in FIG. 2, the MFP1 comprises a controller board 60, an operation panel 53, the FCU 68, the scanner engine 51, and the plotter engine 52. The FCU 68 includes the unit 69 corresponding to G3 specification, and the unit 70 corresponding to G4 specification.

The controller board 60 comprises a CPU 61, an ASIC 66, a HDD 65, a local memory (MEM-C) 64, a system memory (MEM-P) 63, a north bridge (NB) 62, a south bridge (SB) 73, a NIC (network interface card) 74, a USB device 75, an IEEE1394 device 76, and a Centronics device 77.

The operation panel 53 is connected to the ASIC 66 of the controller board 60. The SB 73, the NIC 74, the USB device 75, the IEEE1394 device 76, and the Centronics device 77 are connected to the NB 62 by the PCI bus.

The FCU 68, the scanner engine 51, and the plotter engine 52 are connected to the ASIC 66 of the controller board 60 by the PCI bus.

In the controller board 60, the local memory 64 and the HDD 65 are connected to the ASIC 66, and the CPU 61 and the ASIC 66 are connected together via the NB 62 of the CPU chip set. If the CPU 61 and the ASIC 66 are connected together via the NB 62 in this manner, countermeasure can be taken when the interface of the CPU 61 is not published.

The ASIC 66 and the NB 62 are not connected via the PCI bus, but they are connected via the AGP (accelerated graphics port) 67. In order to carry out execution control of one or more processes which form the application layer 5 and the controller layer 6 in the software composition of FIG. 1, the ASIC 66 and the NB 62 are connected via the AGP 35, not via the low-speed PCI bus. Thus, it is possible to prevent the fall of performance.

The CPU 61 performs control of the whole MFP1. The CPU 61 starts the NCS 30, the DCS 31, the ECS 34, the MCS 35, the UCS 37, the CCS 39, the SCS 38, the SRM 40, the FCUH 41 and the IMH 42, as the processes on the OS, respectively, and performs execution processing of them. At the same time, the CPU 61 starts the printer application 20, the copy application 21, the fax application 22, the scanner application 23, the network file application 24, and the SDK 26, which form the application layer 5, and performs execution processing of them.

The NB 62 is a bridge for connecting the CPU 61, the system memory 63, the SB 73 and the ASIC 66 together. The system memory 63 is a memory used for image drawing of the MFP1. The local memory 64 is a memory used as the image buffer for copying and as the code buffer. The system memory 63 and the local memory 64 correspond to the SRAM 99 in the composition of FIG. 1. The SB 73 is a bridge for connecting the NB 62, the PCI bus and the peripheral device together.

The ASIC 66 is an application-specific IC for image-processing application, which includes the hardware elements for image processing. The HDD 65 is a storage device for performing accumulation of image data, accumulation of document data, accumulation of programs, accumulation of font data, accumulation of forms, etc. The operation panel 53 is an operation unit which receives the input operation from the user and outputs the display message to the user.

Furthermore, a certification and charge device is added to the above-described hardware composition of the MFP1 if needed. In the present embodiment, the device which uses any of a keycard, a coin rack, a multifunction (MF) keycard, a key counter, and an extended device is provided as the certification and charge device.

Next, the CCS (certification and charge control service) 39 will be explained. The CCS 39 provides the functions equivalent to the authentication/charging/user restriction functions which are conventionally provided by the SCS 38. With introduction of the access roll (personal authentication by user login) for security enhancement, the CCS 39 manages the information (restriction information) related to the use possible function (or the use impossible function) corresponding to the authorized individual. The CCS 39 is provided so that, when a new authentication/charging method is introduced, it can easily extend the body program of the MFP1.

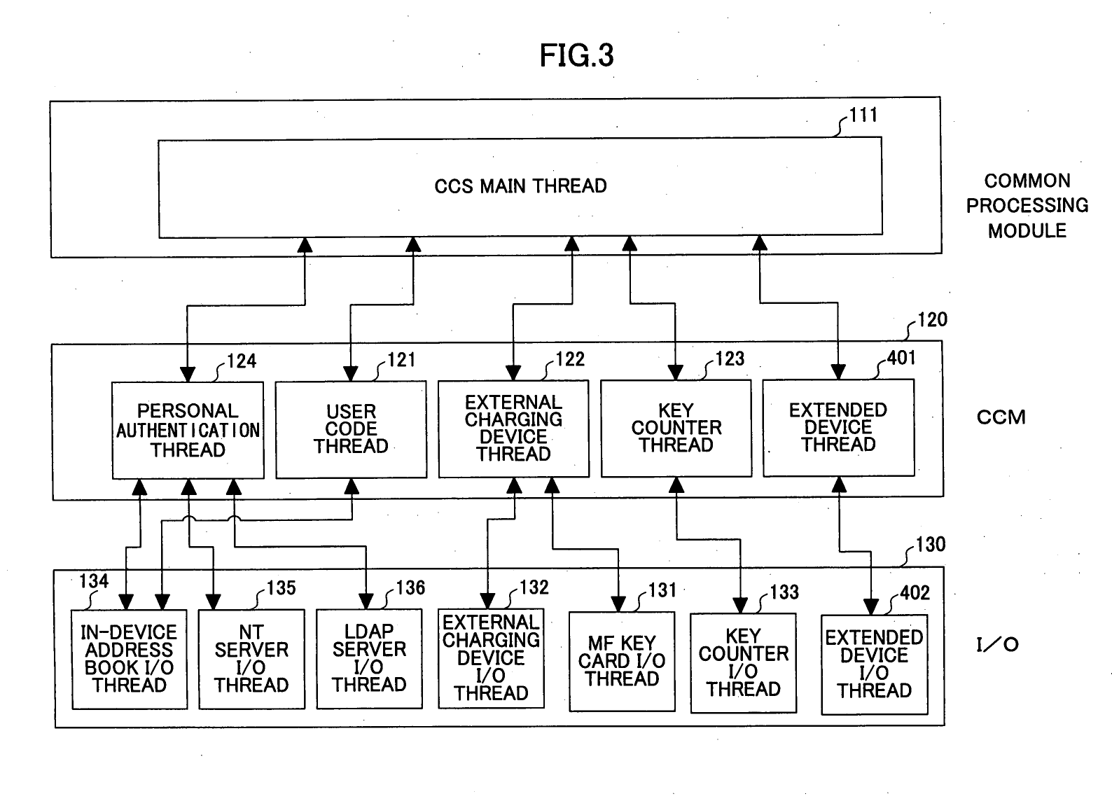

FIG. 3 shows the thread composition of the CCS 39 in the software group 2 of the MFP1 of FIG. 1. As shown in FIG. 3, the thread composition of the CCS 39 includes a CCS main thread 110 which is the common processing module, a CCM 120 and an IO 130.

The CCS main thread 110 is an interface of the application or other modules, and it is the main control module which controls the authenticating processing, charging processing, screen creation processing, etc. The created screen is displayed on the operation panel 53.

The CCM 120 comprises respective certification and charge modules, including a personal authentication thread 124, a key counter thread 123, an external charging device thread 122 and a user code thread 121, as well as an extended device thread 401.

The CCM 120 is the module which performs authenticating processing, charging processing, and screen creation processing in accordance with each of the respective authentication methods. The authentication/charging modules are provided for the respective authentication/charging devices. Each authentication/charging module is a thread having the same composition, and the corresponding authentication/charging module operates in accordance with the operation setting instruction which indicates what kind of operation should be carried out.

The personal authentication thread 124 performs the basic authentication, the Windows (registered trademark) authentication, and the LDAP authentication. If the basic authentication is specified at the time of device registration, the personal authentication thread 124 uses a user name and a password, and performs authenticating processing using the in-device address book.

If the Windows authentication is specified at the time of device registration, the personal authentication thread 124 uses a user name and a password, and performs authenticating processing using a Windows_NT server.

If the LDAP authentication is specified at the time of device registration, the personal authentication thread 124 uses a user name and a password, and performs authenticating processing using an LDAP server.

The user code thread 121 performs authentication which uses the user code. The key counter thread 123 is a thread for use when the key counter is used as the authentication/charging device. The external charging device thread 122 is a thread for use when the keycard, the coin rack or the MF keycard is used as the authentication/charging device.

The extended device thread 401 is a thread corresponding to the authentication/charging device which is newly extended and post-installed.

The MFP1 is provided with the extended device thread 401 and the extended device I/O thread 402 as the exclusive threads for allowing a new authentication device and a new authentication method to be newly extended and post-installed.

Next, the IO 130 which provides specific input/output means related to the authentication/charging processing will be explained.

The IO 130 comprises an in-device address book I/O thread 134, a NT server I/O thread 135, a LDAP server I/O thread 136, an external charging I/O thread 132, a MF keycard I/O thread 131, a key counter I/O thread 133, and an extended device I/O thread 402. And the IO 130 communicates with each module of the application layer 5 or the service layer 7, or each certification and charge device, and receives the authentication state of each device or sends an authentication request thereto.

The in-device address book I/O thread 134 performs communication related to the in-device address book. The in-device address book is the information related to the user's address acquired through the UCS 37. The NT server I/O thread 135 is a thread which communicates with the server which performs the Windows (registered trademark) authentication mentioned above. The LDAP server I/O thread 136 is a thread which communicates with the server which performs the LDAP authentication mentioned above.

The external charging I/O thread 132 communicates with an external charging device, keycard or coin rack. The external charging device, keycard or coin rack is a device in the case where the keycard or the coin rack is used. The MF keycard I/O thread 131 communicates with the MF keycard charging device. The MF keycard is the keycard to which various functions are given in addition to the above-mentioned keycard. The key counter I/O thread 133 communicates with the key counter 142. The extended device I/O thread 402 communicates with the authentication/charging device.

In the following explanation, each thread that belongs to the CCM 120 is referred to as CCM. Similarly, each thread that belongs to the I/O 130 is referred to as IO. As shown in FIG. 1, CCM and IO may exist as two or more threads.

In the following explanation, the extended device I/O thread may be referred to as the extended CCM. The extended device thread may be referred to as the extended CCM.

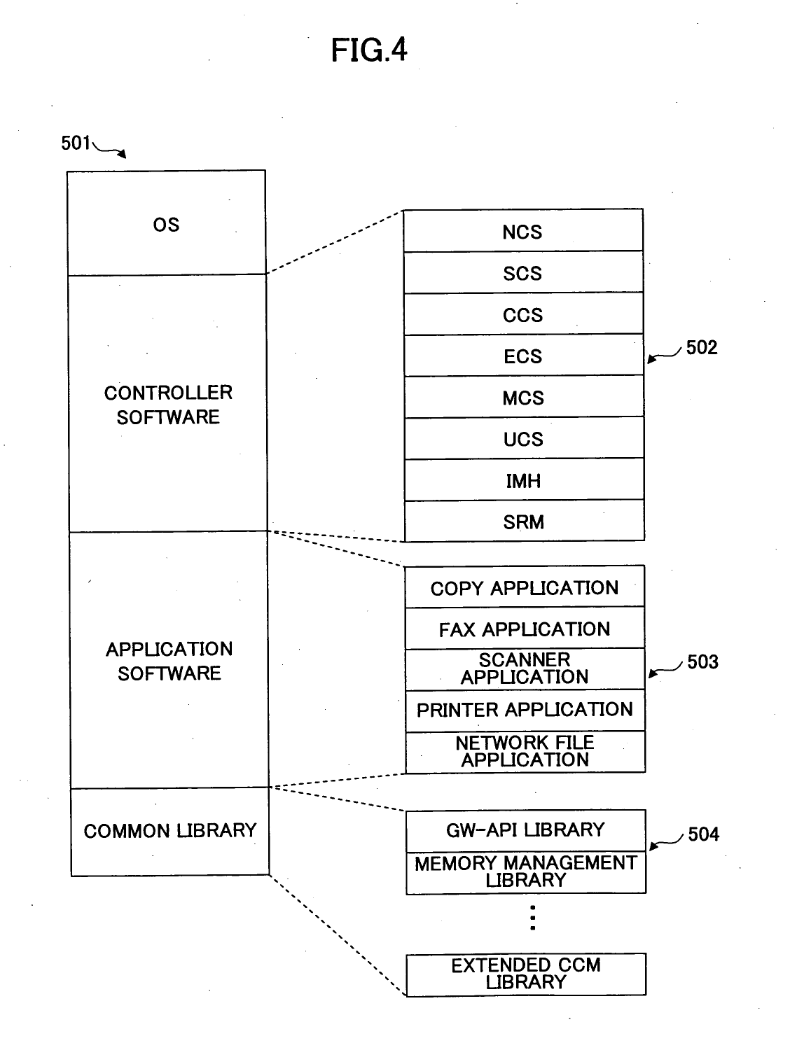

Next, the arrangement of the programs in the ROM will be explained with reference to FIG. 4.

The ROM maps 501, 502, 503 and 504 are shown in FIG. 4. The ROM map 501 indicates the whole ROM map. As indicated in the ROM map 501, the OS (operating system), the controller software, the application software, and the common library are arranged in the ROM.

The ROM map 502 indicates the details of the controller software, the ROM map 503 indicates the details of the application software, and the ROM map 504 indicates the details of the common library.

As indicated in the ROM map 504, the extended CCM library is arranged as a program which is separated from the CCS included in the ROM map 502, and it is possible to add the extended CCM later.

Next, the ROM map when the SD card (registered trademark) on which the programs are recorded is used will be explained.

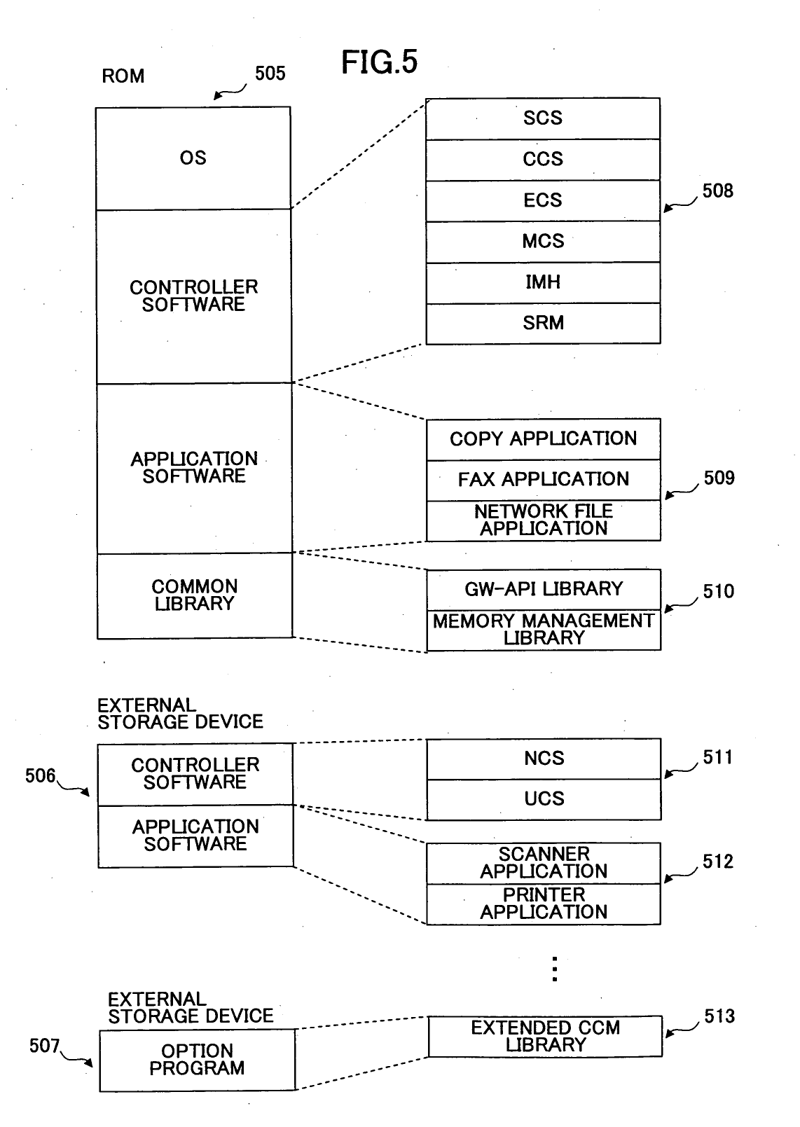

The ROM maps 505, 506, 507, 508, 509, 510, 511, 512 and 513 are shown in FIG. 5.

The ROM map 505 indicates the whole ROM map. As indicated in the ROM map 505, the OS (operating system), the controller software, the application software, and the common library are arranged in the ROM, and those details except the OS are indicated in the ROM maps 508, 509 and 510 respectively.

The ROM map 506 indicates the arrangement of the programs in the SD card, and the controller software and the application software are arranged therein. The ROM map 511 indicates the details of the controller software, and the ROM map 512 indicates the details of the application software.

The ROM map 507 indicates the arrangement of programs in another SD card, and the option program is arranged therein. The ROM map 513 indicates the details of the option program.

Thus, when the MFP1 has the external storage device (such as the SD card) other than the ROM, the MFP1 is able to operate using the program currently recorded on the SD card. It is possible for this multi-function peripheral (MFP) to distribute the extended CCM library, indicated in the ROM map 513, by means of the form of the SD card, instead of the downloading.

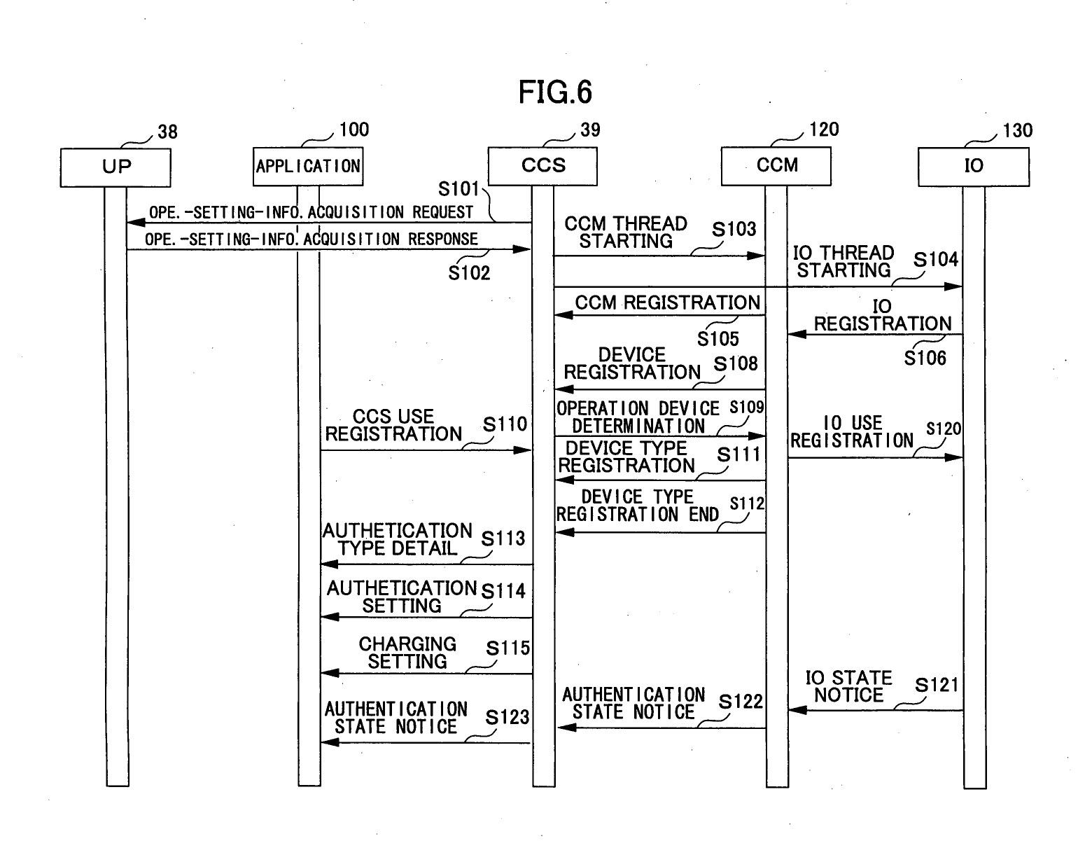

Next, the starting procedure of CCS and CCM will be explained with reference to FIG. 6. FIG. 6 is a sequence diagram for explaining the starting procedure which is performed between the UP 38, the application 100, the CCS 39, the CCM 120 and the IO 130.

As described above, the UP 38 is the user program management module included in the system control service (SCS) 38, and this user program management module is a program which manages the user setting information for use in the authentication and charging processing. Both CCM and IO are usually started as one or more threads. However, for the sake of simplicity of description, only one thread is displayed for each of CCM and IO. The CCM and IO which are explained with reference to FIG. 6 are not the modules corresponding to extended devices, but they are the normal modules.

As shown in FIG. 6, the CCS 39 transmits an operation-setting-information acquisition request to the, UP 38 at step S101. The CCS 39 receives an operation-setting-information acquisition response from the UP 38 at step S102. The MFP1 is provided so that the operation setting of the authentication/charging processing can be chosen by the user (which indicates whether it is used or not) according to the environment which is utilized by the user.

The CCS 39 sends to the UP 38 an inquiry about the operation setting information specified by the user before starting of CCM and IO, and acquires from the UP 38 the user specified information (or the device operation setting information) concerning the authentication/charging processing currently set up by the user.

The CCS 39 at step S103 performs thread starting of the corresponding CCM according to the acquired operation setting information. The CCS 39 at step S104 performs thread starting of the corresponding IO according to the acquired operation setting information. Accordingly, the CCM 120 and the IO 130 are started.

As previously described with FIG. 3, the CCS software group for controlling the authentication/charging of the MFP1 comprises the CCS main which is the main control module, the CCM which performs the authentication/charging processing, and the IO which provides specific input/output means related to the authentication/charging processing. Since it is necessary that the processing of the CCM or the IO operates asynchronously with the control of the CCS main, the processing of the CCM or the IO is realized in the form of the thread. In order to perform the thread control, it is necessary to perform the thread starting. For this reason, the CCS 39 starts the required number of the threads which are equivalent to the CCM and the IO.

In a case in which the CCM and the IO are mounted not in the form of the thread but in the form of independent processes, it is not necessary for the CCS 39 to perform thread starting of the CCM and the IO.

The CCM 120 at step S105 performs CCM registration to the CCS 39. In order to make expandability of software high, the CCS software group is not provided so that each thread recognizes what kind of other threads exist. Only the CCS 39 which performs the main control recognizes the number of the threads which are started. For this reason, communication between the CCM 120 and the CCS 39 is established after the CCM 120, which is started as the thread at the step S103, notifies its existence to the CCS 39 as the destination of the communication.

Similarly, the IO 130 performs IO registration to the CCM 120 at step S106. Communication between the IO 130 and the CCM 120 is established after the IO 130, which is started as the thread at the step S104, notifies its existence to the CCM 120 as the destination of the communication.

Subsequently, at step S108, the CCM 120 performs device registration to the CCS 39. In order to make expandability of software high, the CCS software group holds, as its internal information, the operation setting information which indicates what kind of operation each thread carries out. For this reason, the started thread needs to notify its operation setting information to the CCS 39 as the destination of the communication. Such processing is referred to as device registration or IO registration.

The CCM 120 performs the device registration to the CCS 39 which performs the main control, and the IO 130 performs the IO registration to the CCM 120 which performs the authentication/charging processing.

For example, in the case of the external charging device thread 122 which is one of the CCM threads, the thread 122 sends, at the time of the device registration, the kind of use device which indicates whether the external charging device like the coin rack, or the MF keycard is used for its authentication/charging processing, to the CCS 39.

Subsequently, at step S109, the CCS 39 carries out a judgment of operation device to the CCM 120. Since the CCS 39 receives the device registration from all the CCM threads at the step S108, the CCS 39 in this step recognizes the setting of operation which can be performed by each thread. The CCS 39 carries out the judgment of operation device by notifying the device operation setting information specified by the user, to the CCM 120 at this step S109, so that each thread may perform operation according to the device operation setting information specified by the user, acquired beforehand from the UP 38 at the above step S102. The operation setting information is not notified to the CCM thread which is not used.

For example, in the case of the external charging device thread 122 which is one of the CCM threads, the thread 122 is capable of performing either the authentication/charging method using the external charging device like a keycard or a coin rack, or the authentication/charging method using the MF keycard. In this case, the CCM 120 (or the external charging device thread 122) notifies such device registration to the CCS 39 at the above step S108, and the CCS 39 sends the notice of the device operation setting information determined at the above step S109, to the CCM 120. By this notice (or the device operation setting information specified by the user), it is requested that the CCM 120 should perform the specified authentication/charging method.

After the notice of the device operation setting information is received at the above step S109, the CCM 120 at step S120 performs IO use registration to the IO 130. After the operation device is determined, the CCM 120 at this step S120 notifies the IO 130 which I/O device should be used as the input/output means for the authentication/charging processing in accordance with the device operation setting information specified by the user. For this reason, each CCM thread can perform IO use registration efficiently.

After the CCS 39 carries out the judgment of operation device at the above step S109, the application 100 at step S110 performs CCS use registration to the CCS 39 as the destination of the communication.

On the other hand, when the notice of the device operation setting information is received at the above step S109, the CCM 120 at step S111 performs device type registration to the CCS 39. In this step S111, the CCM 120 notifies a detailed operation setting of the authentication/charging method to the CCS 39. For example, in the device type registration, the CCM 120 notifies, to the CCS 39, the authentication period which indicates that the state during authentication is held until a logout, or it is temporary authentication, as well as the authentication kind which indicates that it is the kind of authentication influencing the whole device or the kind of authentication influencing only the applicable unit, etc.

This device type registration may be performed two or more times for each operation setting.

After all the device type registration is completed, the CCM 120 at step S112 notifies the end of the device type registration, to the CCS 39.

Subsequently, at step S113, the CCS 39 notifies the authentication type details to the application 100. This notice is performed only to the application which has performed the CCS use registration at the above step S110.

The CCS 39 notifies the authentication setting to the application 100 at step S114. The CCS 39 notifies the charging setting to the application 100 at step S115.

Although the application 100 acquires the setting information related to the authentication/charging processing by receiving the notices of the authentication/charging setting, the CCS 39 performs the operation instructions of authentication/charging if needed (this is not performed by the application 100), in order to absorb the difference among various certification and charge methods.

On the other hand, the IO 130 at step S121 sends a notice of IO state to the CCM 120. By this notice, the IO 130 notifies its IO state to the CCM 120. The CCM 120 at step S122 sends a notice of authentication state corresponding to the IO state notice, to the CCS 39. And the CCS 39 at step S123 sends the same notice of authentication state to the application 100. The timing that the IO 130 sends the notice of IO state to the CCM 120 may be, for example, a timing of occurrence of a certain event in the image forming device, such as insertion of a keycard.

In the above-described processing, the thread starting performed by the CCS 39 is unnecessary when the CCM and the IO are mounted in the form of the independent processes, not in the form of the threads.

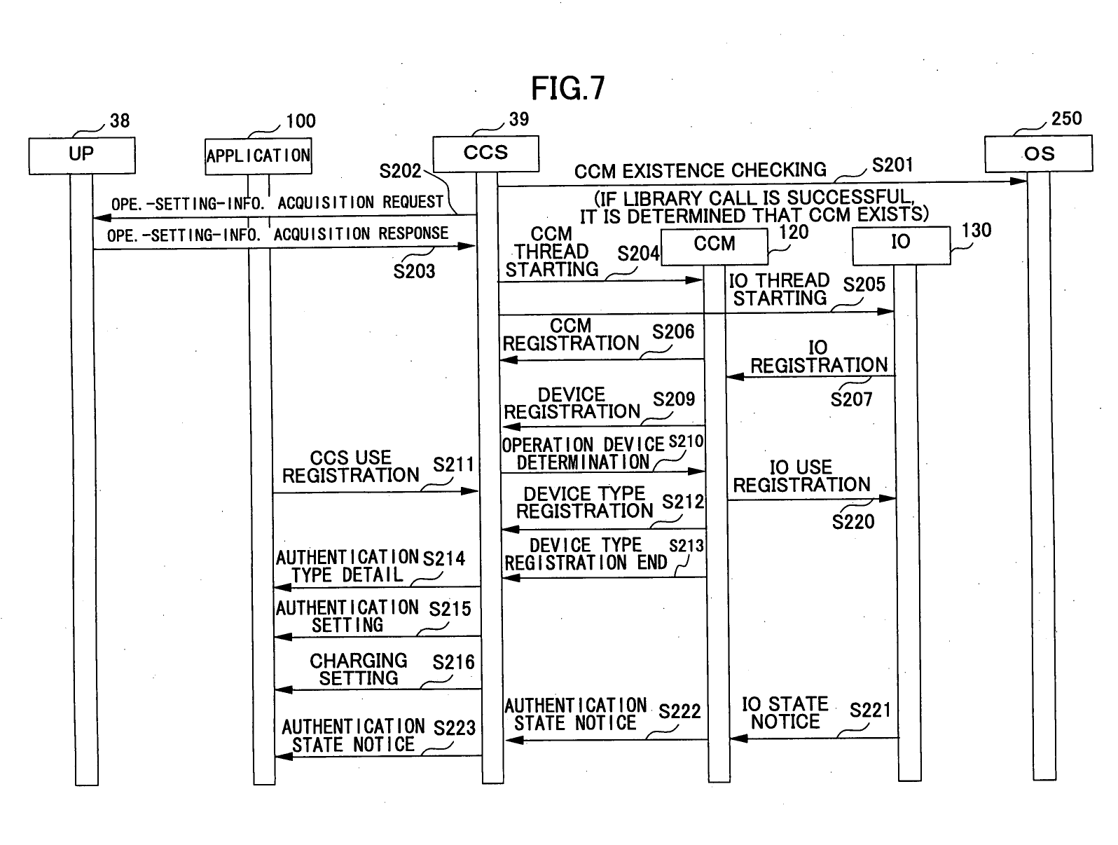

FIG. 7 is a sequence diagram for explaining the starting procedure of the extended CCM and the extended IO.

As shown in FIG. 7, the CCS 39 at step S201 outputs a library call of the extended CCM and the extended IO, to the OS 250. If a successful response is received from the OS 250 as a result of the library call, the CCS 39 determines that the extended CCM and the extended IO exist.

The CCS 39 performs the starting processing of the various CCM threads including the extended CCM, only when the extended CCM exists. On the other hand, when the extended CCM does not exist, the CCS 39 performs the starting processing of the various CCM threads except the extended CCM.

The procedure of steps S202-S207, S209-S216 and S220-S223 of FIG. 7 is essentially the same as the procedure of steps S101-S106, S108-S115 and S120-S123 of FIG. 6, and a description thereof will be omitted.

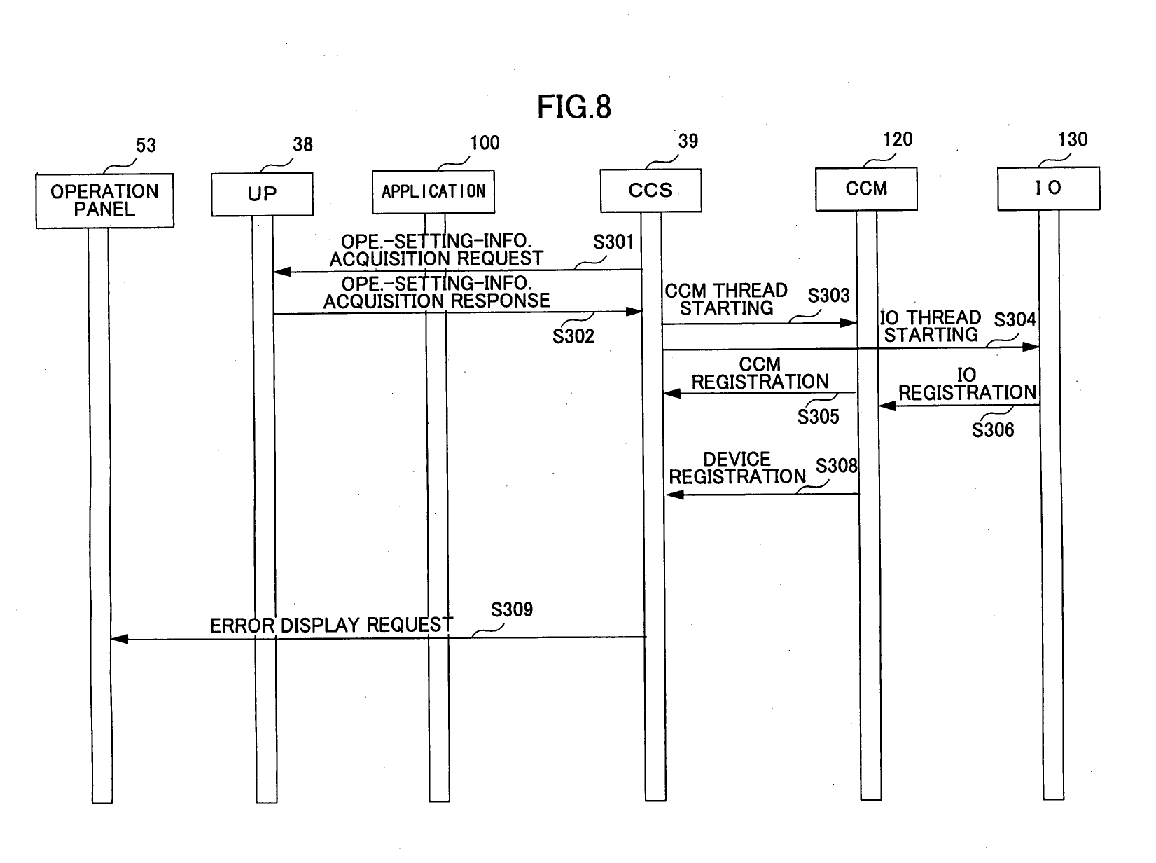

FIG. 8 is a sequence diagram for explaining an error judgment processing at the time of starting of CCS and CCM.

The procedure of steps S301-S306 and S308 of FIG. 8 is essentially the same as the procedure of steps S101-S106 and S108 of FIG. 6, and a description thereof will be omitted.

As shown in FIG. 8, when any device registration event does not occur due to the extended CCM corresponding to the device operation setting after the device registration is performed at step S308, the CCS 39 determines that an error occurs.

Namely, when the extended CCM concerned does not perform the device registration although the operation setting information is acquired by the UP 38, it is determined that an error occurs. Fundamentally, this error occurs only when the extended CCM corresponding to the extended device is used.

Subsequently, at step S309, the CCS 39 transmits an error display request to the operation panel 53.

The reason for performing the error judgment when the extended CCM is used will be explained as follows. Since the extended CCM is an option module of the MFP1 which is to be post-installed, it may be included in the main part of the MFP1, and there is a possibility that the formal evaluation may not be carried out, unlike other CCMs to which the formal evaluation is carried out.

For this reason, it is necessary to perform the error judgment processing as shown in FIG. 8.

Since the extended CCM is constituted as a program other than the body program of MFP1, it may have failed in installation of software.

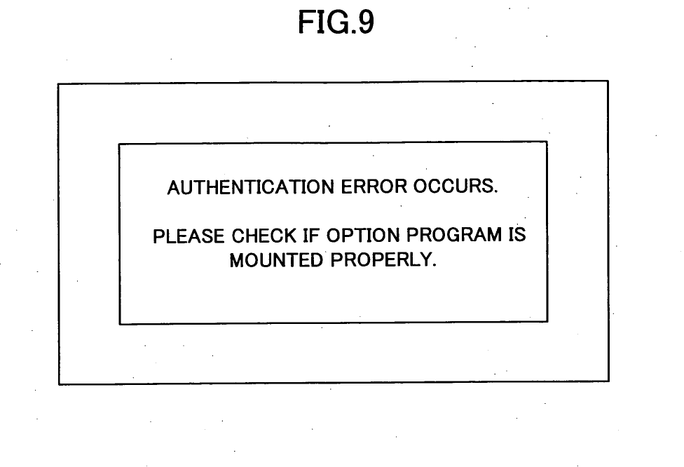

FIG. 9 shows an example of the error screen displayed on the operation panel 53 as a result of the error judgment processing of FIG. 8.

As shown in FIG. 9, the message which indicates the occurrence of an authentication error and requests the user to perform the checking as to whether the option program is properly mounted is displayed on this error screen.

Namely, the error screen of FIG. 9 is provided to include the display message which indicates the cause of the error and the restoration method of the error.

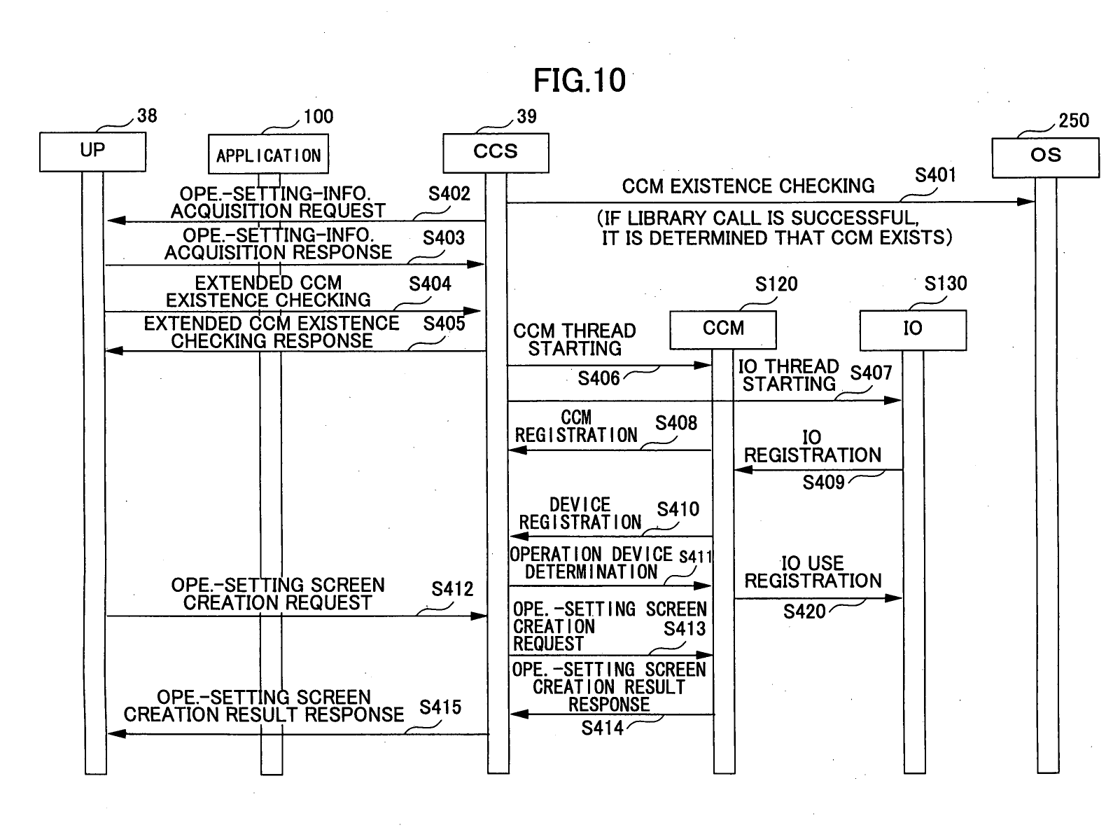

Next, the processing which creates the operation setting screen to be displayed on the MFP at the time of setting of the operation of the extended CCM and the extended IO will be explained with reference to FIG. 10.

Since the extended CCM and the extended IO are option modules, the operation setting screen cannot be prepared beforehand by using the body program of the MFP. For this reason, it is necessary to create an operation setting screen at the time of a setting of operation of the extended CCM and the extended IO.

Therefore, the image data of the operation setting screen is created by the CCM 120, and the creation result is notified to the UP 38.

The procedure of step S401 of FIG. 10 is essentially the same as the procedure of step S201 of FIG. 7, the procedure of steps S402-S403 of FIG. 10 is essentially the same as the procedure of steps S101-S102 of FIG. 6, and a description thereof will be omitted.

As shown in FIG. 10, the UP 38 at step S404 transmits an extended CCM existence checking request to the CCS 39. The CCS 39 determines that the extended CCM exists, if a successful response is received from the OS 250 as a result of the library call (refer to step S401).

In response to the checking request of step S404, the CCS 39 at step S405 notifies the judgment result to the UP 38 by sending the extended CCM existence checking response.

The procedure of steps S406-S411 and S420 of FIG. 10 is essentially the same as the procedure of steps S103-S109 and S120 of FIG. 6, and a description thereof will be omitted.

When the notice of operation device determination is received at step S411, the CCM 120 at step S420 performs the IO use registration to the IO 130.

Meanwhile, the UP 38 at step S412 transmits an operation setting screen creation request to the CCS 39.

In response to the request, the CCS 39 at step S413 transmits an operation setting screen creation request to the CCM 120.

The CCM 120 creates the image data of the operation setting screen, and the CCM 120 at step S414 sends an operation setting screen creation result response to the CCS 39.

In response to the response, the CCS 39 at step S415 notifies the operation setting screen creation result response to the UP 38. This notice is to notify the UP 38 of the completion of creation of the operation setting screen.

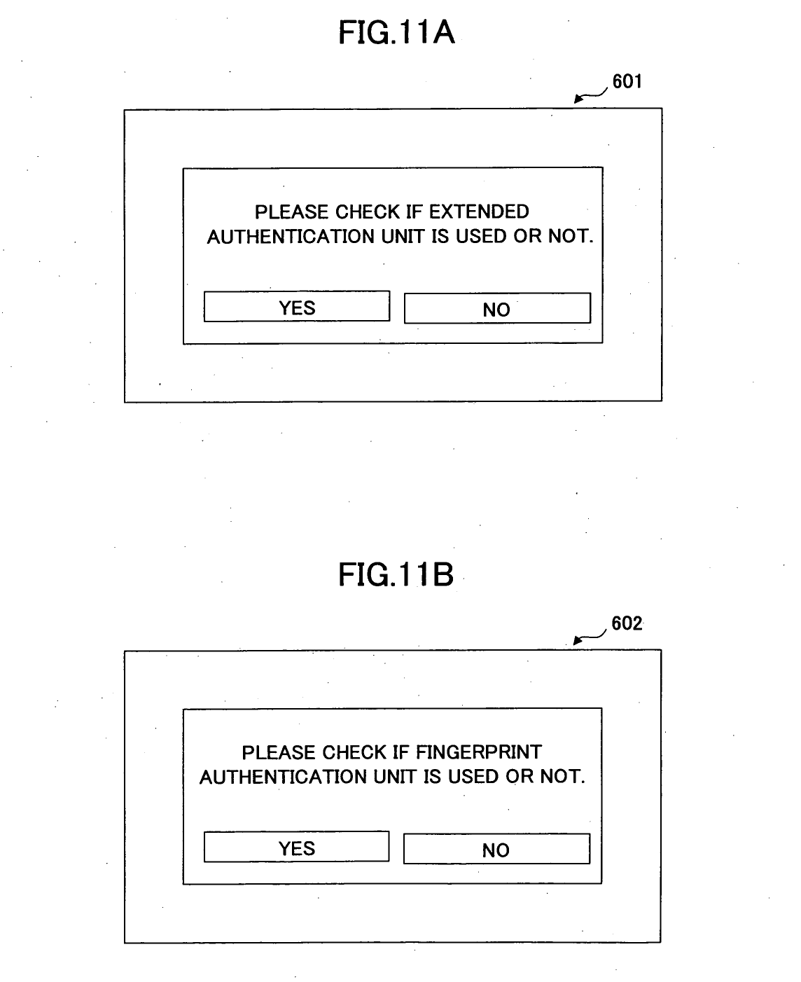

FIG. 11A and FIG. 11B show examples of the operation setting screen created by the processing of FIG. 10. Two screens 601 and 602 which are the screens containing the character string are shown in FIG. 11A and FIG. 11B.

In the screen 601 shown in FIG. 11A, the message “please check if the extended authentication unit is used or not” and the two selection buttons “yes” and “no” are indicated.

When the screen is created using the general term, such as “extended authentication unit”, it is also possible to create the screen on the side of the UP.

In the screen 602 shown in FIG. 11B, the message “please check if the fingerprint authentication unit is used or not” and the two selection buttons “yes” and “no” are indicated.

When the screen is created using the concrete term, such as “fingerprint authentication unit”, it is required to create the screen on the side of the extended CCM which recognizes autonomously what kind of authentication unit it is.

In the above-described embodiments, the IO corresponds to the communication unit in the claims, the CCM corresponds to the authentication control unit in the claims, and the combination of the IO and the CCM corresponds to the application-specific authentication unit in the claims.

The CCS corresponds to the common authentication unit in the claims. The UP corresponds to the device management setting menu unit in the claims. The extended device thread corresponds to the extended authentication control unit in the claims. The extended device I/O thread corresponds to the extended communication unit in the claims.

The CCS 39 performing the step S201 of outputting the library call to the OS 250 as shown in FIG. 7 corresponds to the existence checking unit in the claims. The step S102 corresponds to the operation-setting-information acquisition step in the claims. The steps S103 and 104 correspond to the starting step in the claims. The step S109 corresponds to the operation judgment step in the claims. The procedure of steps S113 to S118 corresponds to the authentication/charging information output step in the claims. The step S309 corresponds to the error message request step in the claims. The step S201 corresponds to the existence checking step in the claims. The step S415 corresponds to the menu output step in the claims.

The present invention is not limited to the above-described embodiments, and variations and modifications may be made without departing from the scope of the present invention.

Further, the present application is based on and claims the benefit of priority of Japanese patent application No. 2005-238753, filed on Aug. 19, 2005, and Japanese patent application No. 2006-161402, filed on Jun. 9, 2006, the entire contents of which are hereby incorporated by reference.

What is claimed is:

1. An image forming device including a hardware resource used in image formation processing, and an application program performing the image formation processing, the image forming device comprising:
at least one application-specific authentication unit specifically adapted for control of one or more of a plurality of authentication/charging methods; and
a common authentication unit providing the application program with a common interface irrespective of a kind of said at least one application-specific authentication unit.

2. The image forming device according to claim 1 wherein the application-specific authentication unit comprises:
a communication unit which communicates with a device used in said one or more of the plurality of authentication/charging methods; and
an authentication control unit which communicates with the device using the communication unit and controls said one or more of the plurality of authentication/charging methods.

3. The image forming device according to claim 2 wherein the communication unit is provided to perform a registration to the application-specific authentication unit to notify existence of the communication unit to the application-specific authentication unit, and the authentication control unit is provided to perform a registration to the common authentication unit to notify existence of the authentication control unit to the common authentication unit.

4. The image forming device according to claim 1 wherein the common authentication unit is provided to send charging setting information to the authentication control unit if needed.

5. The image forming device according to claim 1 further comprising a device management setting menu unit controlling displaying of an authentication-related operation setting menu to a user, and the common authentication unit determining contents of the operation setting menu in accordance with operation setting information registered by the authentication control unit.

6. The image forming device according to claim 5 wherein the displayed operation setting menu includes a character string.

7. The image forming device according to claim 2 wherein the common authentication unit is provided to start the authentication control unit only when the authentication control unit is predetermined as being started.

8. The image forming device according to claim 1 further comprising:
an extended communication unit adapted for an extended authentication method; and
an extended authentication control unit adapted for control of the extended authentication method.

9. The image forming device according to claim 8 wherein the extended communication unit and the extended authentication control unit are recorded on another storage medium separated from the image forming device, and the image forming device is provided to start the extended communication unit and the extended authentication control unit from said storage medium.

10. The image forming device according to claim 8 further comprising an existence checking unit checking whether the extended authentication control unit exists.

11. The image forming device according to claim 10 wherein, when it is checked by the existence checking unit that the extended authentication control unit does not exist, an error message, including a cause of an error and a restoration method of the error, is displayed.

12. An authentication charging method for use in an image forming device including a hardware resource used in image formation processing and an application program performing the image formation processing, the method comprising:
acquiring, from a device management setting menu unit, operation setting information which indicates a kind of authentication method or charging method specified by a user;
starting an application-specific authentication unit corresponding to the acquired operation setting information, the application-specific authentication unit being specifically adapted for control of one or more of a plurality of authentication/charging methods and including a communication unit and an authentication control unit;
determining contents of operation setting of the authentication control unit in accordance with the operation setting information and notifying the contents of the operation setting to the started application-specific authentication unit; and
notifying the contents of the operation setting and a current authentication state to the application program.

13. The authentication charging method according to claim 12 further comprising the step of outputting an error message request when an error occurs in the application-specific authentication unit, in order to display the occurrence of the error to the user.

14. The authentication charging method according to claim 12 wherein the image forming device further comprises an extended authentication unit adapted for an extended authentication method, and an existence checking unit checking existence of the extended authentication unit, and
wherein, when the extended authentication unit is started, the existence checking unit is used to check existence of the extended authentication unit.

15. The authentication charging method according to claim 14 wherein, when the extended authentication unit is used, the device management setting menu unit is requested to display an operation setting menu corresponding to the extended authentication unit.

16. A computer-readable recording medium having program code stored thereon which, when executed by a computer, causes the computer to perform an authentication charging method for use in an image forming device including a hardware resource used in image formation processing and an application program performing the image formation processing, the method comprising:
acquiring, from a device management setting menu unit, operation setting information which indicates a kind of authentication method or charging method specified by a user;
starting an application-specific authentication unit corresponding to the acquired operation setting information, the application-specific authentication unit being specifically adapted for control of one or more of a plurality of authentication/charging methods and including a communication unit and an authentication control unit;
determining contents of operation setting of the authentication control unit in accordance with the operation setting information and notifying the contents of the operation setting to the started application-specific authentication unit; and
notifying the contents of the operation setting and a current authentication state to the application program.
